(19) United States
(12) Patent Application Publication
(10) Pub. No.: US 2017/0140135 A1
(43) Pub. Date: May 18, 2017

(54) PASSWORD INPUT METHOD, TERMINAL APPARTUS AND ELECTRONIC DEVICE

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Yu ZHAO, Beijing (CN)

(73) Assignees: Le Holdings (Beijing) Co., Ltd., Beijing (CN); LE SHI INTERNET INFORMATION & TECHNOLOGY CORP., BEIJING, Beijing (CN)

(21) Appl. No.: 15/240,408

(22) Filed: Aug. 18, 2016

Related U.S. Application Data
(63) Continuation of application No. PCT/CN2016/083750, filed on May 27, 2016.

(30) Foreign Application Priority Data
Nov. 16, 2015 (CN) 201510784712.1

(51) Int. Cl. G06F 21/31; G06F 21/62

(52) U.S. Cl. CPC G06F 21/31; G06F 21/6218

(57) ABSTRACT

The present disclosure provides a password input method, a terminal apparatus and an electronic device. Here, the password input method includes detecting press operations performed on a password input interface of a terminal apparatus by a user; and obtaining a first password by resolving pressures corresponding to the press operations. According to the password input method, the terminal apparatus and the electronic device, a password input is achieved by user's press operations on a password input interface, so that the operation is more convenient and secure.

### CROSS-REFERENCE TO RELATED APPLICATION

The present application is a continuation of International Application No. PCT/CN2016/083750 with an international filing date of May 27, 2016, which is based upon and claims priority to Chinese patent application No. 201510784712.1 with title “Password Input Method and Terminal Apparatus”, filed on Nov. 16, 2015, the entire disclosure of which is herein incorporated by reference in its entirety.

### BACKGROUND

Technical Field

The present disclosure relates to a technical field of terminal application, and more particularly, to a password input method, a terminal apparatus and an electronic device.

Description of the Related Art

As terminal apparatuses are commonly used, there have been increased security requirements for the terminal apparatuses. For mobile phones, for example, users may typically protect contents in the mobile phone from being seen by others by means of setting passwords. When a user needs to unlock the screen, he/she inputs a pre-set password for unlocking to unlock the screen. FIG. 1 is an exemplary schematic diagram of a screen unlocking method according to the prior art. Referring to FIG. 1, most commonly used screen unlocking methods include “Slide to Unlock”, “Number Unlock”, “Number/Letter Combination Unlock”, “Fingerprint Unlock”, “Pattern Unlock”, etc.

However, the above mentioned screen unlocking methods at least have following problems: 1) the Slide to Unlock method is simple and works on a low security level; 2) when a pattern password or number password to unlock is used, the area for operation is relatively large, the gesture is apparent, the operation is prone to snooping, and it works on a low security level; 3) although a number/letter combination password is relatively complex and is hard to be cracked, its input through a keyboard is also complicated and hard to operate; and 4) although the fingerprint password unlock mechanism increases security and convenience, hardware devices (for example, fingerprint sensors) are required, not suitable for all types of terminal apparatuses.

### SUMMARY

The objection of the embodiments of the present disclosure is to provide a password input method, a terminal apparatus and an electronic device, in which a password is input by a user's press operations on a password input interface, so that the convenience and security of the operation are improved.

According to an aspect of the embodiments of the present disclosure, there is provided a password input method including: detecting press operations performed on a password input interface of a terminal apparatus by a user; and obtaining a first password by resolving pressures corresponding to the press operations.

According to another aspect of the embodiments of the present disclosure, there is also provided a terminal apparatus including a press operation detecting module configured to detect press operations performed on a password input interface of the terminal apparatus by a user; and a press operation resolving module configured to obtain a first password by resolving pressures corresponding to the press operations.

According to another aspect of the embodiments of the present disclosure, there is also provided an electronic device, the electronic device including: a memory for storing a program; and a processor for execute the program stored in the memory, the memory making the processor to execute instructions of the above mentioned password input method.

According to another aspect of the embodiments of the present disclosure, there is also provided a computer program, the computer program including a computer readable code, which when executed on an electronic device, causes the electronic device to execute instructions for the above mentioned password input method.

According to another aspect of the embodiments of the present disclosure, there is also provided a computer readable medium, on which the above mentioned computer program is stored.

According to the password input method, the terminal apparatus and the electronic device of the embodiments of the present disclosure, the input of password is achieved by detecting press operations performed on a password input interface by the user and further resolving pressures of the press operations. The convenience and security of the password input operation are improved. Therefore, a brand new and more plentiful operation experience is brought to the user, and the user experience is improved.

It is to be noted that the general descriptions above and the detailed descriptions that follow are merely exemplary and descriptive, and cannot limit the present application.

### BRIEF DESCRIPTION OF THE DRAWINGS

For clarity of descriptions on the embodiments of the present application, accompanying drawings used in descriptions on the embodiments are briefly introduced below. It is apparent that the accompanying drawings described below merely cover certain embodiments of the present application and that those skilled in the art can obtain, without exerting creative efforts, other drawings from these accompanying drawings.

FIG. 1 is an exemplary diagram illustrating a screen unlock method according to prior art;

FIG. 2 is a flow chart illustrating a password input method according to a first embodiment of the present disclosure;

FIG. 3 is an exemplary view illustrating a password input interface according to the first embodiment of the present disclosure;

FIG. 4 is a logic block diagram illustrating a terminal apparatus of a second embodiment of the present disclosure;

FIG. 5 is a structural diagram illustrating a computer device provided by a third embodiment of the present disclosure.

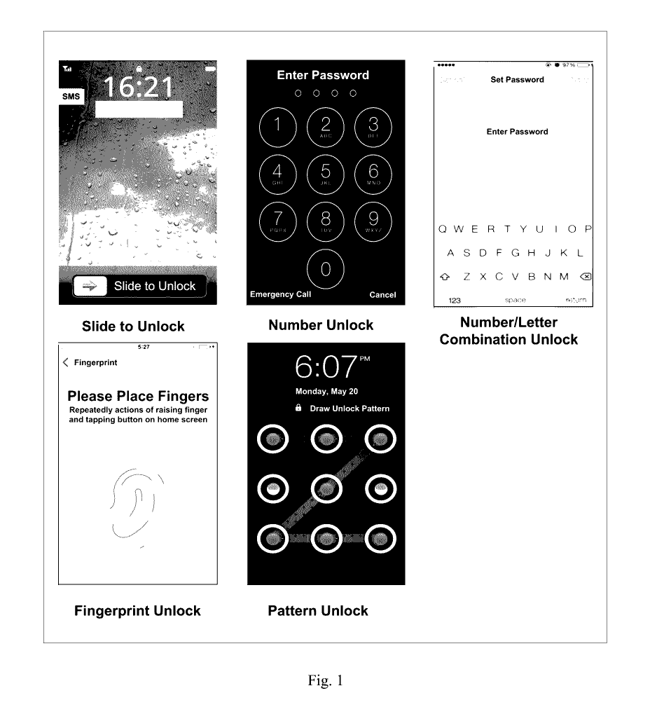

Particular embodiments of the present application have been shown with reference to the above accompanying drawings, and more detailed descriptions will be given hereinafter. These accompanying drawings and literal descriptions are not intended to limit the scope of the inventive concepts by any means, but rather the inventive concepts are explained with reference to the particular embodiments for those skilled in the art.

### DETAILED DESCRIPTION

A basic concept of the present disclosure is to provide a technical solution of inputting a password based on detecting a user pressing a password input interface of a terminal apparatus, so that the operation of inputting a password is faster, more convenient and more secure, improving user experience.

Take a user setting a screen unlock password as an example. First, when a user performs an operation of setting a password, he/she inputs the password by way of pressing on the screen, wherein each press operation may correspond to a symbol, for example, a letter or digit; or alternatively, a plurality of press operations may also correspond to a preset Morse code rule. Also, a terminal apparatus may store the screen unlock password set by the user. Next, when the user performs an operation of unlocking the screen, the terminal apparatus may obtain a pre-stored screen unlock password and match the password input by the user with the pre-stored screen unlock password; if the matching is successful, the screen is successfully unlocked, and if the matching is not successful, the unlocking fails.

Therefore, in the above mentioned password input procedure, the operating area is relatively small, and the operating method is simple and is resistant to snooping. Therefore, according to the basic concept of the present disclosure, the convenience and security of operations may be improved. Also, various password input means are provided for users, further improving the user experience.

The password input method, the terminal apparatus and the computer device according to embodiments of the present disclosure are described in combination with the drawings as follows.

### First Embodiment

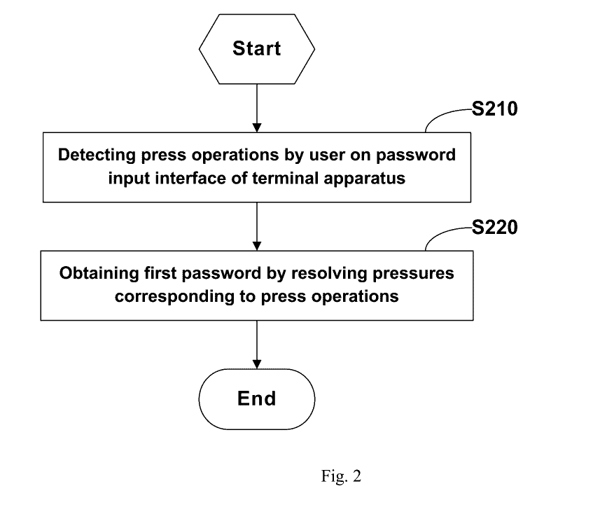

FIG. 2 is a flow chart illustrating a password input method according to a first embodiment of the present disclosure. The entity executing the method may be a terminal apparatus, for example, a cell phone, a pad, etc., or a device integrated within the terminal apparatus. The present embodiment is explained with a terminal apparatus as the executing entity.

Referring to FIG. 2, at step S210, press operations on a password input interface of the terminal apparatus pressed by a user are detected.

It should be noted that the press operations may include a combination of press operations with various pressures or strengths. In an implementation, a plurality of gestures may be recognized by the terminal apparatus, for example, a tap operation, a drag operation, a long pressing operation, a press operation, etc., wherein tap and long pressing operations are different from press operations in that the duration of a tap operation is short and the tap operation is performed by the user through only touching, other than t hard pressing, the touch screen of the terminal apparatus.

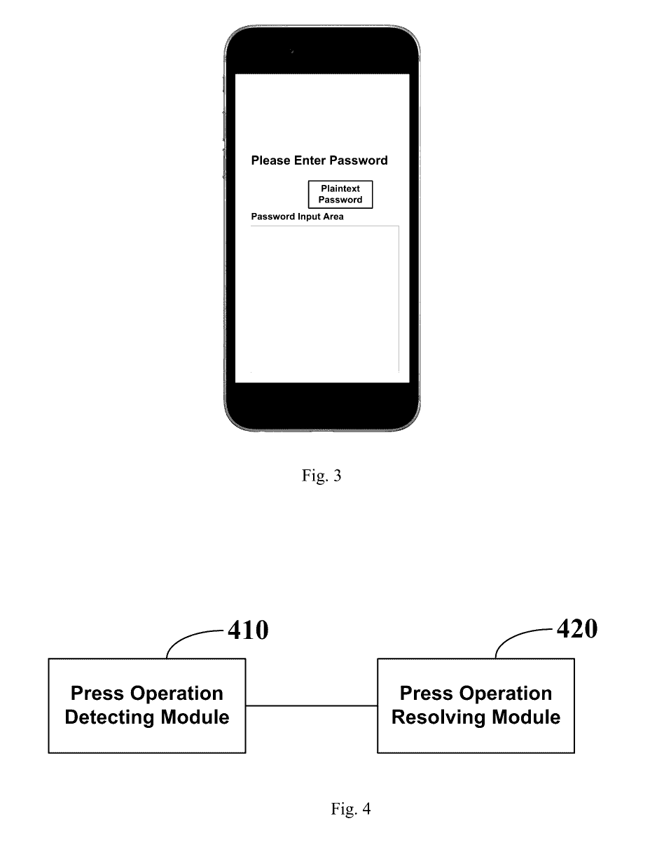

In particular, FIG. 3 is an exemplary view illustrating a password input interface according to the first embodiment of the present disclosure. Referring to FIG. 3, the terminal apparatus provides for the user a given password input area, within which a password input interface may be pressed (such as light press, hard press) when the user inputs a password. A pressure sensor may be provided in the terminal apparatus, which may be placed in a display component (such as a touch screen) for detecting press operations of the user. When the user presses the display component, the pressure sensor may measure the pressure applied by the press operation. If the pressure is within a predetermined pressure range, the press operation may be determined as valid, and then the terminal apparatus may perform processing corresponding to the press operation.

At step S220, the pressures corresponding to the press operation is resolved and a first password is obtained.

For the above mentioned step, the press operations by the user on the password input interface of the terminal apparatus are detected, which originates from two situations: one is a situation that the user needs to unlock the terminal apparatus by inputting a password, and the other is a situation that the user needs to set a password for the terminal apparatus.

Therefore, the above mentioned password input interface may be a password unlock input interface. Accordingly, according to an exemplary embodiment of the present disclosure, step S220 includes: resolving a pressure corresponding to each of the press operations into a password symbol; and obtaining the first password by arranging the resolved password symbols in the sequence of their corresponding press operations. Here, the password symbols may be letters or digits, that is, the pressure corresponding to each press operation may be resolved as one letter or one digit, for example, a certain pressure of a press operation is resolved as letter “A”, so that the first password may be obtained by sequentially arranging the resolved letters or digits.

After the above mentioned explanation of directly resolving letters or digits from various pressures, according to another exemplary embodiment of the present disclosure, step S220 includes, resolving pressures corresponding to the press operations as a Morse code symbol sequence and obtaining a first password by looking up a pre-stored Morse code corresponding relationship table according to the Morse code symbol sequence.

In particular, one pressure is resolved into one Morse code symbol, then the Morse code symbol sequence is obtained by arranging the resolved Morse code symbols in the input order, and the Morse code symbol sequence is converted into the first password according to the pre-stored Morse code corresponding relationship table.

As mentioned above, the user may perform a long pressing operation or a heavy pressing operation on the display interface (such as the password input interface) of the terminal apparatus. Here, the heavy pressing operation is a multi-point touch technology in the 3D touch technology. Such technology may enable the screen to sense various pressures, including two types of operations, namely, Peek (light press) and Pop (hard press). The present embodiment takes advantage of the above function. The operations of user pressing on the password input interface correspond to symbols of Morse code.

Morse code, also named Morse electric code, is an on-off signal code. Different English letters, digits and punctuation marks are represented in different arrangement orders. A Morse code is indicated with two basic signal and various time intervals. Here, a short dot signal “•” referred as “dot” (Di), and a long signal holding for a certain of time “-” referred as “dash” (Da). The interval between dots is 1t, the interval between dashes is 3t, and the interval between dot and dash is 1t, wherein “t” is a time interval unit.

Here, a light press indicates a Morse code symbol “•”, and a hard press indicates a Morse code symbol “-”, and a pause between a light press and a hard presses indicates a time interval, where a “pause” refers to not pressing the password input interface. For example, it is assumed that the user needs to set “tina” as password. Referring to FIG. 3, the user performs press operations of a combination of hard and light presses within the password input area provided by the terminal apparatus. At this time, the terminal apparatus detects such press operations, and resolve the detected press operations of a combination of hard and light presses into the Morse code symbol sequence (- . . - . . -). The following Table 1 illustrates a Morse code corresponding relationship table. The first password “tina”, input by the user is obtained through a look up of Table 1.

| | Morse code |
|---|---|
| Character | symbol |
| A | ·— |
| B | —··· |
| C | —·—· |
| D | —·· |
| E | · |
| F | ··—· |
| G | — —· |
| H | ···· |
| I | ·· |
| J | ·——— |
| K | —·— |
| L | ·—·· |
| M | — — |
| N | —· |
| O | — —— |
| P | ·——· |
| Q | — —·— |
| R | ·—· |
| S | ··· |
| T | — |
| U | ··— |
| V | ···— |
| W | ·—— |
| X | —··— |
| Y | —·—— |
| Z | — —·· |
| 1 | ·———— |
| 2 | ··——— |
| 3 | ···—— |
| 4 | ···— |
| 5 | ····· |
| 6 | —···· |
| 7 | — —··· |
| 8 | — ——·· |
| 9 | — ———· |
| 0 | — ———— |
| ? | ··——·· |
| / | —··—· |
| 0 | —·——·— |
| — | —····— |
| . | ·—·—·— |

After the first password is obtained, the password input method may further include, obtaining a pre-stored second password, and performing a unlock operation when the first password and the second password match.

Further, when the first password and the second password do not match, a password error may be prompted to the user. Also in the above mentioned example of password “tina”, assuming the pre-stored second password is “tina” and the first password is obtained from resolving pressures corresponding to press operations is “tina”, a comparison between the first password and the second password is performed, and the match is successful and the unlock operation is performed. If a Morse code symbol sequence (- . . . _ . -) is resolved and obtained from the detected press operations of the combination of hard and light presses, a first password “tiaa” is obtained by looking up the pre-stored Morse code corresponding relationship table, and the pre-stored second password is “tina”, then obviously, the first password and the second passwords do not match, and a password error is prompted for the user.

In particular, in order for the terminal apparatus to prompt the user that the password input by the user is not correct, the terminal apparatus may generate a password error warning icon and display the icon at a pre-set area of the display interface of the terminal apparatus; and/or, the terminal apparatus may generate a password error warning tone which may then be replayed on the terminal apparatus; and/or, a password error warning light is generated and shown by controlling the display screen and/or flash light of the terminal apparatus .

In the present embodiment, the password input interface may also be a password setting input interface, and accordingly, the password input method may also include storing the first password.

In an implementation, the set password may be stored in a form of a plaintext or a cipher. For example, when the terminal apparatus stores a password “tina”, a plaintext “tina” may be stored, or a cipher “- . . - . .-” may be stored. Referring to FIG. 3, the password input interface provides two storing manners for the user to select.

According to the password input method of the embodiment of the present disclosure, the input of password is achieved by resolving the pressures of the detected press operations performed on the password input interface by the user. The password input operation is made more convenient and secure. Therefore, various password input methods are provided to the user, which greatly improves user experience.

### Second Embodiment

FIG. 4 is a logic block diagram illustrating a terminal apparatus of a second embodiment of the present disclosure. The terminal apparatus may perform the steps of the method as illustrated in FIG. 2.

Referring to FIG. 4, the terminal apparatus includes a press operation detecting module 410 and a press operation resolving module 420. The press operation detecting module 410 is connected with the press operation resolving module 420.

The press operation detecting module 410 is configured to detect press operations performed by the user on the password input interface of the terminal apparatus. Preferably, the press operations may include a combination of press operations with different pressures.

The press operation resolving module 420 is configured to resolve the pressures corresponding to the press operations to obtain a first password.

More specifically, for the process of resolving the pressures corresponding to the press operations, two scenarios are present, in one of which each press operation is resolved into one letter or digit and a password is obtained from the resolved letters or digits, and in the other of which the press operations are resolved into a Morse code symbol sequence and a password is obtained from the Morse code symbol sequence.

Therefore, according to an exemplary embodiment of the present disclosure, the password input interface may be a password unlock input interface, and the press operation resolving module 420 may include:
a press operation resolving unit (not illustrated), configured to resolve the pressure corresponding to each press operation into one password symbol;
a first password generating unit (not illustrated), configured to obtain the first password by arranging the resolved password symbols according an input order.

Accordingly, in accordance with another exemplary embodiment of the present disclosure, the password input interface may be a password unlock input interface, and the press operation resolving module 420 may include:
a press operation resolving unit (not illustrated), configured to resolve the pressures corresponding to the press operations into a Morse code symbol sequence.
a first password generating unit (not illustrated), configured to obtain the first password by looking up a pre-stored Morse code corresponding relationship table according to the Morse code symbol sequence resolved by the press operation resolving unit.

Further, the terminal apparatus may further include:
a second password obtaining module (not illustrated), configured to obtain a pre-stored second password.
a password matching module (not illustrated), configured to perform unlock operation when the first password and the second password match.

What needs to be explained is that a password input is needed mainly in two situation, one in which a password needs to be input when the password is to be set, and the other in which the password needs to be input during unlocking, that is, the above mentioned password input interface is the password unlock input interface.

According to another exemplary embodiment of the present disclosure, the password input interface may be a password setting input interface, and accordingly, the terminal apparatus may further include a first password storing module (not illustrated) configured to store the first password.

According to the terminal apparatus provided by the embodiment of the present disclosure, the input of password is achieved by detecting the press operation by the user performed on the password input interface and further resolving the pressures of the press operations. The password input operation is more convenient and secure. Therefore, a brand new and more rich operation experience is brought to the user.

### Third Embodiment

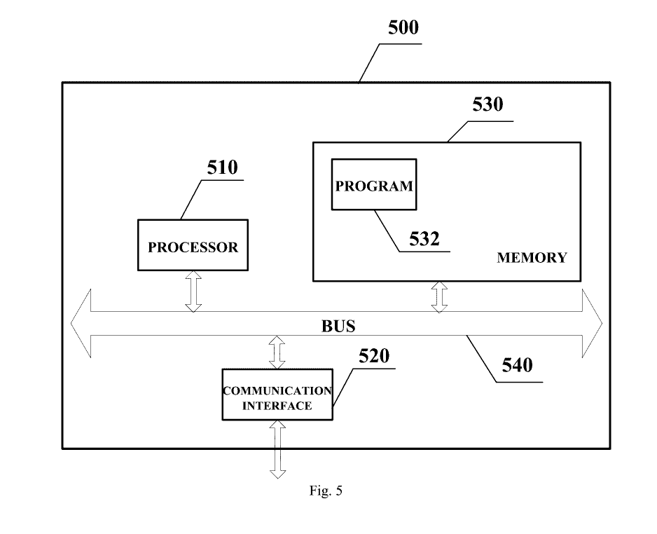

FIG. 5 is a structural diagram illustrating a computer device provided by a third embodiment of the present disclosure. The implementation of the computer device is not specifically defined by the present application. Referring to FIG. 5, the electronic device 500 may include a processor 510, a communication interface 520, a memory 530 and a communication bus 540.

The processor 510, the communication interface 520 and the memory 530 perform communication with one another through the communication bus 840.

The communication interface 520 is adapted to communicate with other network units.

The processor 510 is adapted to execute a program 532, for performing corresponding steps described in the above embodiments for the method in particular.

Specifically, the program 532 may include program codes, which include computer executable instructions.

The processor 510 may be a central processing unit (CPU), or an Application Specific Integrated Circuit (ASIC), or one or more integrated circuits configured to implement the embodiments of the present application.

The memory 530 is adapted to store the program 532. The memory 530 may contain a high speed RAM memory or may contain a non-volatile memory, such as at least one magnet disk memory. The program 532 is specifically configured to enable the computer device 500 to perform the operations below: detecting the press operations by the user performed on the password input interface of the terminal apparatus and resolving the pressures corresponding to the press operations and obtaining a first password.

In one alternative embodiment, the program 532 may further be configured to enable the computer device 500 to perform the operations below: resolving a pressure corresponding to each press operation into one password symbol and obtaining the first password by arranging the resolved password symbols according an input order.

In one alternative embodiment, the program 532 may further be configured to enable the computer device 500 to perform the operations below: resolving the pressures corresponding to the press operations into a Morse code symbol sequence and obtaining the first password by looking up a pre-stored Morse code corresponding relationship table according to the Morse code symbol sequence.

In one alternative embodiment, the program 532 may further be configured to enable the computer device 500 to perform the operations below: obtaining a pre-stored second password and performing unlock operation when the first password and the second password match.

Descriptions on corresponding steps and units in the above embodiments may be referred to for particular implementations of the operations performed in the program 532, and are not repeatedly described herein. Those skilled in the art can clear appreciate that for convenience and conciseness, the particular processing in the embodiment for the method can be referred to for the corresponding processing of the apparatus and modules described above, and is not repeatedly described herein.

In addition, the embodiments of the present application also provide a computer program, which includes computer executable code. When the computer executable code is executed on the computer device, the computer device is caused to perform the password input method described in any one of the embodiments of the multiple methods described above.

Also, the embodiments of the present application also provide a computer readable medium, on which the above computer program is stored.

Through the technical solutions provided in the embodiments of the present application, the input of password is achieved by detecting the press operation performed on a password input interface by the user and further resolving the pressures of the press operations. The password input operation is more convenient and secure. Therefore, a brand new and more plentiful operation experience is brought to the user.

Further, typically, the electronic device of the embodiments of the present disclosure may be various hand-held terminal apparatus, for example, a cell phone, a Personal Digital Assistant (PDA), etc., and therefore, the protection scope of the present disclosure is not to be limited to some specific electronic device.

Also, the method addressed in the present application can also be implemented by a computer program executed by a CPU, which can be stored in a computer readable medium. When the computer program is executed by its CPU, the functions defined above in the method of the present application are performed.

Also, steps in the above method and system units may be implemented by a controller and a computer readable medium for storing a computer program causing the controller to execute the above steps or unit functions.

Also, it is to be understood, the computer readable medium mentioned herein (e.g. memory) can be a volatile memory or a non-volatile memory, or can include both. As an example, but not limited to, the non-volatile memory can include a read-only memory (ROM), a programmable ROM (PROM), an electrically programmable ROM (EPROM), an electrically erasable programmable ROM (EEPROM), or a flash memory. The volatile memory can include randomly accessible memory, which serves as external high speed cashing memory. As an example, but not limited to, the RAM can be obtained from various ways, such as synchronous RAM (SRAM), dynamic RAM (DRAM), synchronous DRAM (SDRAM), double data rate SDRAM (DDR SDRAM), enhanced SDRAM (ESDRAM), synchronous link DRAM (SLDRAM) and direct Rambus RAM (DRRAM). The storage devices according to aspects of the present application can include these memories and any memories of other suitable types, but not limited thereto.

Those skilled in the art should also appreciate that various exemplary logic blocks, modules, circuits and algorithmic steps incorporated in the present application can be implemented as electronic hardware, computer software or both. For clear explanation of such interchangeability between hardware and software, general descriptions have been given on functions of various exemplary components, blocks, module, circuits and steps. Whether such functions are implemented in software or hardware depends on an implementation and design constraints imposed on the entire system. Those skilled in the art can implement such functions with respect to each particular application and in a variety of manners, but such implementation decision cannot be construed as out of the scope of the present application.

Various exemplary logic blocks, modules, circuits and algorithmic steps incorporated in the present application can be designed to be implemented or performed by a component(s) listed below for executing the functions described herein: a general processor, a digital signal processor (DSP), an application specific integrated circuit (ASIC), a field programmable gate array (FPGA) or other programmable logic device, split gate or transistor logic, separate hardware components, or any combination of these components. A general processor can be a microprocessor, but alternatively, can be any traditional processors, controllers, microcontrollers, or state machines. Processors can also be implemented as a combination of a computing device, for example, a combination of multiple microprocessors and DSP, multiple microprocessors, one or more microprocessor in combination with a DSP core, or any other such configuration.

Various exemplary steps of the method or algorithm incorporated in the present application can be directly incorporated in hardware, software module executed by the processor or the combination of the two. The software modules can reside in a RAM, a flash memory, a ROM, an EPROM, an EEPROM, a register, hard disk, removable disk, CD-ROM or storage medium in any other known form in the art. An exemplary storage medium is coupled into a processor, enabling the processor to read information from the storage medium or to write information into the storage medium. In an alternative mode, the storage medium can be incorporated with the processor. The processor and the storage medium may reside in an ASIC, which may reside in a user terminal. In an alternative mode, the processor and the storage medium may reside in the user terminal as separate components.

In one of more exemplary designs, these functions can be implemented in hardware, software, firmware or any combination of the above. If the functions are implemented in software, they can be stored in a computer readable medium or transmitted through a computer readable medium as one or more instructions or code. Said computer readable medium include computer storage medium or transmission medium which includes any medium that facilitates transmission of a computer program from one location to another. Said storage medium may be any usable medium that are accessible by a general purpose computer or dedicated computer. As an example, but not limited to, said computer readable medium can include RAM, ROM, EEPROM, CD-ROM or any other optic storage device, disk storage device or any other magnetic storage device, or may be any other medium for carrying or storing program code in the form of instructions or data structures and accessible by general purpose computers or dedicated computers or general purpose or special use processors. Also, any connections can be suitably called computer readable medium. For example, if software is transmitted from a website, a server or any other remote source via a coaxial cable, optic cable, twisted-pair cable, digital subscriber line (DSL) or wireless technology such as infrared, radio and microwave, then said coaxial cable, optic cable, twisted-pair cable, digital subscriber line (DSL) or wireless technology such as infrared, radio and microwave all fall in the definition of the medium. As used herein, magnetic disks and optic disks include compact discs (CD), laser discs, optic discs, digital versatile discs, floppy disks and blue-ray discs, wherein magnetic disks typically reproduce data magnetically while optic disks reproduce data optically using laser. The combination of the above should also fall in the scope of a computer readable medium.

Exemplary embodiments are given above, but it should be noted that these are merely disclosed exemplary embodiments. On the premise of not violating the scope of the present application defined in the claims, various change and modifications can be done. The functions, steps and/or actions defined in the method claims of the embodiments do not necessarily be performed in any particular order. Also, although elements of the present application may be described or claimed in a singular form, said elements can be seen as plural, unless specifically limited to being singular.

It should be noted, unless otherwise supported clearly in the context, a singular form “a” (“a”, “an”, “the”) is intended in included plural forms. It should be noted that the phrasing of “and/or” in this text refers to inclusion of any one of one or more items associated listed or a combination of all of the items.

The above reference numerals in the embodiments of the present application are merely for description purpose and do not indicate the advantages or disadvantages of the embodiments.

Those skilled in the art can appreciate that all or parts of the steps in the above embodiments can be completed via hardware or through programs instructing hardware. Such programs can be stored in a computer readable storage medium, which may be read-only storage, magnetic disks or optical disks, etc.

The above are merely particular implementations of the present application, but the protection scope of the present application is not limited thereto. Any one skilled in the art can readily conceive of changes or substitutions in the technical scope as disclosed in the present application, which changes or substitutions should all fall in the protection scope of the present application. Therefore, the protection range of the present application should be determined only by the accompanying claims.

What is claimed is:

1. A password input method, comprising:
detecting press operations performed on a password input interface of a terminal apparatus by a user; and
obtaining a first password by resolving pressures corresponding to the press operations.

2. The method of claim 1, wherein the press operations comprise a combination of press operations with various pressures.

3. The method of claim 2, wherein the password input interface is a password unlock input interface, and the obtaining the first password by resolving pressures corresponding to the press operations comprises:
resolving a pressure corresponding to each press operation into a password symbol; and
obtaining the first password by arranging the resolved password symbols according an input order.

4. The method of claim 2, wherein the password input interface is a password unlock input interface, and the obtaining the first password by resolving pressures corresponding to the press operations comprises:
resolving the pressures corresponding to the press operations into a Morse code symbol sequence; and
obtaining the first password by looking up a pre-stored Morse code corresponding relationship table according to the Morse code symbol sequence.

5. The method of claim 2, wherein the method further comprises:
obtaining a pre-stored second password; and
performing an unlock operation when the first password and the second password match.

6. The method of claim 1, wherein the password input interface is a password unlock input interface, and the obtaining the first password by resolving pressures corresponding to the press operations comprises:
resolving a pressure corresponding to each press operation into a password symbol; and
obtaining the first password by arranging the resolved password symbols according an input order.

7. The method of claim 1, wherein the password input interface is a password unlock input interface, and the obtaining the first password by resolving pressures corresponding to the press operations comprises:
resolving the pressures corresponding to the press operations into a Morse code symbol sequence; and
obtaining the first password by looking up a pre-stored Morse code corresponding relationship table according to the Morse code symbol sequence.

8. The method of claim 1, wherein the method further comprises:
obtaining a pre-stored second password; and
performing an unlock operation when the first password and the second password match.

9. An electronic device, comprising:
a memory for storing a program; and
one or more processor(s) for execute the program stored in the memory,
where in the program contains instructions that cause the processor(s) to:
detect press operations performed on a password input interface of a terminal apparatus by a user; and
obtain a first password by resolving pressures corresponding to the press operations.

10. The electronic device of claim 9, wherein the press operations comprise a combination of press operations with various pressures.

11. The electronic device of claim 10, wherein the processor(s) is/are further configured to:
resolve a pressure corresponding to each press operation into a password symbol; and
obtain the first password by arranging the resolved password symbols according an input order.

12. The electronic device of claim 11, wherein the processor(s) is/are further configured to:
resolve the pressures corresponding to the press operations into a Morse code symbol sequence; and
obtain the first password by looking up a pre-stored Morse code corresponding relationship table according to the Morse code symbol sequence.

13. The electronic device of claim 12, wherein the processor(s) is/are further configured to:
obtain a pre-stored second password; and
perform an unlock operation when the first password and the second password match.

14. The electronic device of claim 11, wherein the processor(s) is/are further configured to:
obtain a pre-stored second password; and
perform an unlock operation when the first password and the second password match.

15. The electronic device of claim 10, wherein the processor(s) is/are further configured to:
obtain a pre-stored second password; and
perform an unlock operation when the first password and the second password match.

16. The electronic device of claim 10, wherein the processor(s) is/are further configured to:
resolve the pressures corresponding to the press operations into a Morse code symbol sequence; and
obtain the first password by looking up a pre-stored Morse code corresponding relationship table according to the Morse code symbol sequence.

17. The electronic device of claim 9, wherein the processor(s) is/are further configured to:
obtain a pre-stored second password; and
perform an unlock operation when the first password and the second password match.

18. A computer readable medium, on which the program of claim 9 is stored.
